(19) United States
(12) Patent Application Publication
(10) Pub. No.: US 2008/0033687 A1
(43) Pub. Date: Feb. 7, 2008

(54) ANALYZING APPARATUS

(75) Inventor: Satoshi YAMAMOTO, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHIMADZU CORPORATION, Nakagyo-ku (JP)

(21) Appl. No.: 11/833,663

(22) Filed: Aug. 3, 2007

(30) Foreign Application Priority Data
Aug. 3, 2006 (JP) 2006-211843

(51) Int. Cl. G01D 1/00

(52) U.S. Cl. 702/127

(57) ABSTRACT

Small analyzing apparatus such as a spectrophotometer and a portable liquid chromatograph are generally used without an external computer for analytical processing connected. The present invention provides an analyzing apparatus of this kind for producing an analysis report easily and quickly based on analysis data. An analyzing apparatus according to the present invention includes an analysis report producer for producing an internal analysis report as a PDF file in a predetermined format based on analysis data obtained as an analysis result. With this analyzing apparatus, it is possible to quickly obtain an analysis report in PDF file format which is easy to handle, and can be viewed in a variety of environments without producing a report on an external computer. The analyzing apparatus may further include a report format selector for displaying plural kinds of formats to be specified by a user.

The present invention relates to an analyzing apparatus or measuring apparatus. More precisely, the present invention relates to an analyzing apparatus or measuring apparatus which includes an analysis report producer therein for producing an analysis report in a predetermined file format based on an analysis result or measuring result.

### BACKGROUND OF THE INVENTION

Nowadays, general-purpose computers are widely used for controlling analyzing apparatuses such as a chromatograph. General-purpose computers are also used for processing and managing data which was obtained as an analysis result. Patent Document 1 discloses a system, which is an example of such data processing apparatuses, for managing and storing analysis results provided from an analyzing apparatus in a form so that these results can be searched easily.

Analyzing apparatus and measuring apparatus include movable or portable ones such as a spectrophotometer and a portable liquid chromatograph. In this specification, such analyzing apparatus or measuring apparatus are called “small analyzing apparatuses”. In general, the small analyzing apparatus types are not controlled by a computer as a control apparatus which is connected at all times but controlled by using functions equipped on the small analyzing apparatus themselves. In this specification, the data obtained as a result of performing an analysis or measuring is uniformly called “analysis data”.

It is normal that not only a control apparatus but also a data processing apparatus (typically, a computer) is not connected to a small analyzing apparatus at all times. When processing analysis data after an analysis is finished, the obtained analysis data is generally provided to external storage devices such as a memory card and USB memory, and then the analysis data is transferred to a computer for data processing. Or, the small analyzing apparatus may be connected directly to an external computer for data processing, and the analysis data is transferred to the computer.

After the analysis data is transferred to a computer for data processing, the computer automatically launches predetermined software or under the instruction of a user to process and analyze the analysis data or create a chart for example.

Patent Document 1: Japanese Unexamined Patent Application Publication No. 2003-173340

Non-Patent Document 1: “PDF Reference”, Adobe Systems Incorporated, Internet <URL:http://www.adobe.comldevnet/pdf/pdf_reference.html>, [April 24, 2007]

### SUMMARY OF THE INVENTION

Unfortunately, conventional processing methods, in which analysis data is transferred to an external computer for data processing and then several processes are executed, take much effort and time until a definitive analysis report is obtained.

Users who use a small analyzing apparatus often want to obtain an analysis report quickly instead of producing a well-produced analysis report. However, the conventional small analyzing apparatus cannot meet such demands

In order to solve the above-described problems, the present invention provides an analyzing apparatus which includes an analysis report producer for producing an analysis report as a PDF file in a predetermined format based on analysis data obtained as an analysis result.

Preferably, the analyzing apparatus may further include a monitor and a report format selector for displaying plural kinds of formats of an analysis report, and the analysis report producer produces an analysis report in a format which was specified by a user among the plural kinds of formats displayed on the monitor.

In an analyzing apparatus according to an embodiment of the present invention, a formatted analysis report which is based on an analysis data is produced in PDF (Portable Document Format) file format. The analyzing apparatus therefore greatly saves the trouble of transferring the analysis data to an external computer and processing the analysis data by using data processing software running on the computer to produce an analysis report.

With an analyzing apparatus according to an embodiment of the present invention, it is not necessary to purchase or develop data processing software which is to be used on an external computer. This leads to cost reduction.

Software (or a viewer) for PDF files, whose file format is that of the analysis report, is widely distributed free of charge regardless of the kind of operating system. In addition, since such a viewer for PDF files is pre-installed or installable not only on computers but also on many portable phones and mobile terminals, the analysis report produced by the analyzing apparatus according to the present invention can be viewed very readily in any environment.

This also means that efforts and cost to develop programs for viewing the analysis report on various platforms are saved.

In addition, PDF files are generally difficult to modify, and therefore, effective to prevent from altering a report once produced. Accordingly, with an analyzing apparatus according to the present invention, it is possible to enhance the reliability of the analysis data and analysis report obtained, in maintaining and storing the analysis results.

In addition, since the file size of a PDF file is generally smaller than that of data before being converted to PDF, it is easy and manageable to save or transfer the analysis report.

An analyzing apparatus according to another embodiment of the present invention may further includes a monitor and a report format selector for displaying plural kinds of formats of an analysis report, and the analysis report producer produces an analysis report in a format which was specified by a user among the plural kinds of formats displayed on the monitor. In this embodiment, it is possible for a user to easily specify a format of an analysis report which meets the user's requirement.

### BRIEF DESCRIPTION OF THE DRAWINGS

FIG. 1 is a block diagram showing a substantial part of an analyzing apparatus in accordance with an embodiment of the present invention.

FIG. 2 is a schematic view showing a report producing process by an analyzing apparatus in accordance with an embodiment of the present invention.

### EXPLANATION OF NUMERALS

1 . . . Analyzing Apparatus

2 . . . Analyzing Component

3 . . . CPU

4 . . . Memory

5 . . . Monitor

6 . . . Input Unit

7 . . . Output Unit

8 . . . Storage

8a . . . OS

8b . . . Report Producing Program

8c . . . Report Definition Information

11 . . . Report Producer

12 . . . Report Format Selector

### DETAILED DESCRIPTION OF PREFERRED EMBODIMENTS

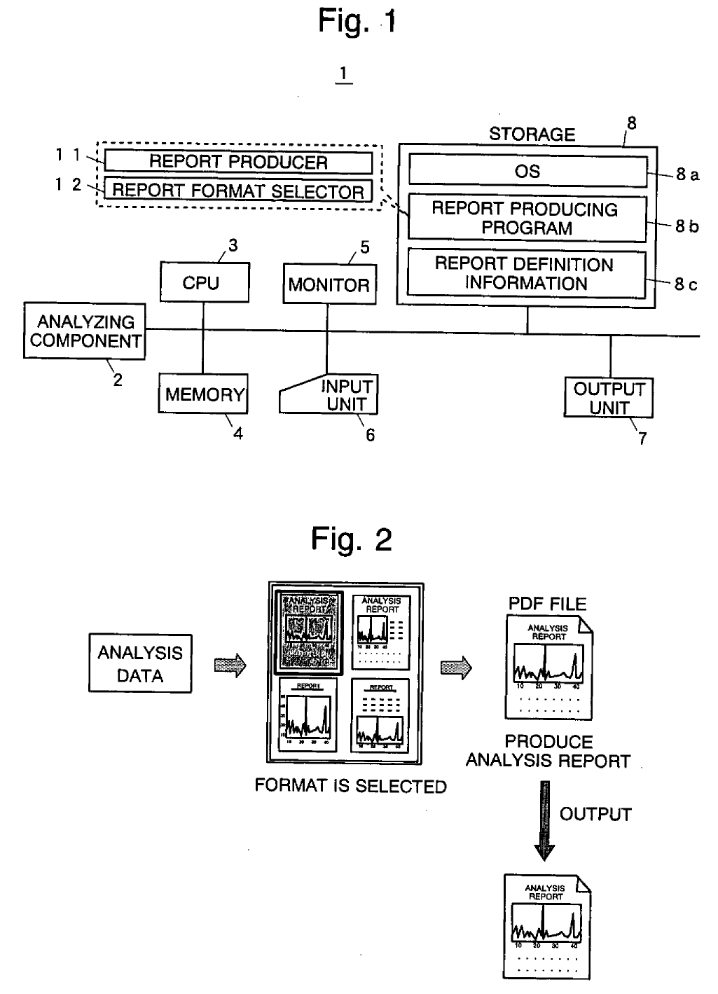

An analyzing apparatus according to an embodiment of the present invention is described with reference to figures. FIG. 1 is a block diagram showing a substantial part of an analyzing apparatus in accordance with the embodiment. As shown in FIG. 1, an analyzing apparatus I includes an analyzing component 2 for executing an intended analysis to obtain analysis data, a CPU 3, a memory 4, a monitor 5, an input unit 6 including a keyboard and/or touch panel for example for receiving instructions entered by users, an output unit 7 for providing an analysis report, and a storage 8 such as a hard disk or flash memory which are data readable/writable storages. These components are connected amongst each other.

The analyzing apparatus 1 controls analytical processing with the CPU 3, memory 4 and predetermined data stored in the storage 8. A detailed description for the analytical processing by the analyzing apparatus 1 is omitted.

The output unit 7 is an interface for data output such as a USB port and memory card slot. The output unit 7 can be a LAN port or RS232C port for communicating with an external computer and a computer or computers on a network by using a proper protocol.

In the storage 8, an OS 8a for fundamentally controlling the analyzing apparatus 1, a report producing program 8b, and report definition information 8c are included.

In the analyzing apparatus according to the present invention, the OS 8a does not have to be stored in the storage 8; it can be stored in a ROM (Read Only Memory) which is placed in the analyzing apparatus 1.

The report producing program 8b is a program for realizing the report producer 11 and the report format selector 12 in accordance with the present invention in software terms, and produces an analysis report in PDF file format based on analysis data provided from the analyzing component 2. In order to produce a report in PDF file format, it is possible to prepare a dedicated program based on the PDF specification published free of charge to the public on the Adobe Systems Incorporated website and use it. This means that there is no need for purchasing a commercial PDF file producing application software, and, consequently, brings about cost reduction.

In addition, since the dedicated program is newly developed, its program size is small and can be executed nimbly; only libraries relating to analysis reports to be produced by the analyzing apparatus 1 are implemented in the report producing program 8b. In contrast, commercial PDF file producing application software for general use generally has numbers of libraries implemented so as to convert data in various file formats to PDF files.

The report producing program 8b can be modified and rewritten as needed. Therefore, should the PDF specification be changed, it would be possible to respond to it easily.

The report definition information 8c is a file in which information on appearances and formats of analysis reports which are produced based on analysis data are described.

The report definition information 8c includes information on where to place display items such as a title, chart, date, and identity number in an analysis report. The report definition information 8c also includes sizes and shapes of the display items to be shown in an analysis report. In addition, the report definition information 8c may include minute definitions for creating charts such as size of axes, display format of scale of axes, and thicknesses and colors of various lines.

In addition, it is preferable that the report definition information 8c further include plural kinds of definition information and exemplary format images to be displayed on the monitor 5 for each kind of definition information so that a user can select a format of an analysis report to be produced.

It is also preferable that the report definition information 8c be modified and rewritten as needed. In this case, the kind of definition information can be added and meticulous needs of users with regard to file formats can be addressed.

Hereinafter, an example of a report producing operation which is executed by the CPU 3 running the report producing program 8b is described with reference to FIG. 2, which is a pattern diagram.

First, an analysis is performed by an analyzing apparatus 1, and analysis data is provided from the analyzing component 2. A user then inputs a report-producing instruction by operating the input unit 6. Receiving the report-producing instruction, the CPU 3 runs the report producing program 8b which is stored in the storage 8. The report producing program 8b may be run automatically without receiving an instruction from the user after analysis data is provided from the analyzing component 2.

Then the CPU 3 (i.e. the report format selector 12) refers to the report definition information 8c and displays plural kinds of exemplary format images (format templates) which the user can select on the monitor 5. In FIG. 2, four kinds of format templates are displayed on the monitor 5, and the format template at the upper left is being selected.

When the user operates the input unit 6 (e.g. cursor buttons and OK button) to specify one certain format template (the upper-left format template in this embodiment), the CPU 3 (i.e. the report producer 11) produces an analysis report as a PDF file based on the analysis data with reference to the report definition information 8c.

Here, the analysis report in PDF file format was produced directly from the analysis data. Alternatively, a temporary report in some file format may be produced first and then the temporary report may be converted to a PDF file.

The analysis report in PDF file format produced as previously described is transferred to an external computer for browsing, portable terminal, or mobile phone via a USB memory, memory card, or communication cable from the output unit 7. Users can review and print out the analysis report by launching a viewer for PDF file on the computer for browsing.

It should be noted that the above-described embodiments are mere examples of the analyzing apparatus according to the present invention, and can be modified or changed within the scope of the present invention as a matter of course.

An analyzing apparatus of the present invention may be an analyzing apparatus which a computer for controlling and data processing is always connected to, although the analyzing apparatus is generally a small analyzing apparatus.

In addition, with an analyzing apparatus of the present invention, it is possible to take advantage of various security-enhancing functions which are included in a PDF specification itself. For example, when producing an analysis report, it is possible to set a password to open the PDF file or it is possible to set the display items in the PDF file not to be copied.

In the above-described embodiment, an analysis report is printed out after it is transferred to an external computer. Alternatively, a printer may be connected to an analyzing apparatus according to the present invention and an analysis report may be printed out directly from the analyzing apparatus.

What is claimed is:

1. An analyzing apparatus comprising an analysis report producer for producing an analysis report as a PDF file in a predetermined format based on analysis data obtained as an analysis result.

2. The analyzing apparatus of claim 1, further comprising;
a monitor; and
a report format selector for displaying plural kinds of formats of an analysis report,
wherein the analysis report producer produces an analysis report in a format which was specified by a user among the plural kinds of formats displayed on the monitor.

3. A computer program product usable with an analyzing apparatus having a report producing program embodied therein, the report producing program when executed by the analyzing apparatus causing the analyzing apparatus to produce an analysis report as a PDF file in a predetermined format based on analysis data obtained as an analysis result.

4. A computer program product usable with an analyzing apparatus having a report producing program embodied therein, the analyzing apparatus having a monitor capable of displaying plural kinds of formats of an analysis report, the report producing program when executed by analyzing apparatus causing the analyzing apparatus to perform the steps of:
displaying plural kinds of formats of an analysis report on the monitor; and producing an analysis report as a PDF file in a format which was specified by a user among the plural kinds of formats displayed on the monitor based on analysis data obtained as an analysis result.
